(19) United States
(12) Patent Application Publication
(10) Pub. No.: US 2006/0211815 A1
(43) Pub. Date: Sep. 21, 2006

(54) Self-emulsifying aqueous polyurethane dispersions

(75) Inventors: Ulrike Licht, Mannheim (DE); Susanne Deutrich, Munster (DE); Heinz-Peter Rink, Munster (DE); Wilma Locken, Haltern (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/553,037

(22) PCT Filed: May 6, 2004
(86) PCT No.: PCT/EP04/04819

§ 371 Date: Oct. 11, 2005

(30) Foreign Application Priority Data
May 16, 2003 (DE) 103 22 266.9

(51) Int. Cl. C08G 18/08

(52) U.S. Cl. 524/591

(57) ABSTRACT

Self-emulsifying aqueous primary dispersions comprising polyurethane, processes for their preparation, and their use.

The present invention relates to self-emulsifying aqueous primary dispersions which comprise polyurethane. The present invention also relates to a process for preparing these primary dispersions, and to their use.

From the prior art it is known that ionic polyurethane dispersions are suitable for paints, impregnating systems, and coatings for textile, paper, leather, and plastics. Numerous aqueous polyurethane adhesives as well are known. The ionic group here not only contributes to dispersibility in water but is also an important constituent of the formula for the purpose of producing ionic interactions which influence the mechanical properties. Preparation in the case of this prior art takes place by the acetone process or prepolymer mixing process.

A disadvantage is that such processes are inconvenient and expensive, especially when solvents are used. Moreover, the reagents used to introduce the hydrophilic groups are expensive specialty chemicals.

German laid-open specification DE-A1 198 25 453 describes, for example, dispersions which comprise polyurethanes. The polyurethanes in question are what are known as self-dispersible polyurethanes, whose self-dispersibility is achieved through incorporation of ionically or nonionically hydrophilic groups. These dispersions are used to impregnate synthetic leather.

From WO 00/29465 it is known that it is possible to react isocyanate and hydroxyl compound in aqueous miniemulsions to form polyurethanes. There is, however, no description of compositions which would make it possible to prepare aqueous coatings or adhesives.

WO 02/64657 describes PU minidispersions containing certain diols, with which a reaction to polyurethane can be achieved without the intermediate step of preparing a prepolymer. The compositions described therein, however, do not meet the dispersibility requirements.

Also known from the prior art are polyurethane coating materials without hydrophilic groups, with or without solvent. These materials, however, have disadvantages in comparison to the dispersions described. Account must be taken in particular of the environmental problems arising from the use of solvents or free isocyanate. A further disadvantage are the molar masses, which are lower than those of the dispersions. Further still, the reaction of isocyanate in an aqueous environment is always accompanied by losses due to formation of urea, which make it impossible directly to adopt known formulas for a hydrophobic polyurethane.

It is an object of the present invention to provide primary dispersions which comprise polyurethane, which are finely divided without the use of high shear forces, and which make it possible not only for the raw materials to be emulsified finely but also for the products to be dispersed.

We have found that this object is achieved by means of an aqueous primary dispersion comprising at least one polyurethane obtainable by reacting
a) at least one polyisocyanate,
b1) at least one polyol containing the structural unit —[—CH₂—CH₂—O—]— one or more times,
b2) if appropriate at least one polyol other than b1),
b3) if appropriate at least one compound containing at least two isocyanate-reactive groups selected from thiol groups and primary and secondary amino groups,
b4) if appropriate at least one monofunctional monomer having an isocyanate-reactive group, and
c) if appropriate at least one ionic or potentially ionic synthesis component,
   wherein
   the fraction of the structural units —[—CH₂—CH₂—O—]—, calculated at 42 g/mol, in the polyol b1) is from 10 to 90% by weight and
   in the sum of the components a)+b1)+b2)+b3)+b4)+c) is at least 3% by weight.

In one preferred embodiment of the invention the ratio of isocyanate groups (a) to isocyanate-reactive groups (b) is from 0.8:1 to 3:1, preferably from 0.9:1 to 1.5:1, more preferably 1:1.

Examples of suitable components a) include aliphatic, aromatic, and cycloaliphatic diisocyanates and polyisocyanates having an NCO functionality of at least 1.8, preferably from 1.8 to 5, and more preferably from 2 to 4, and also their isocyanurates, biurets, allophanates, and uretdiones.

The diisocyanates are preferably isocyanates having 4 to 20 carbon atoms. Examples of suitable diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Preference is given to aliphatic and cycloaliphatic diisocyanates, and particular preference to isophorone diisocyanate, tetramethylxylylene diisocyanate (m-TMXDI), and 1, 1-methylenebis[4-isocyanato]cyclohexane (H₁₂MDI).

Suitable polyisocyanates include polyisocyanates comprising isocyanurate groups, uretdione diisocyanates, polyisocyanates containing biuret groups, polyisocyanates comprising urethane groups or allophanate groups, polyisocyanates comprising oxadiazinetrione groups, uretonimine-modified polyisocyanates of linear or branched C₄-C₂₀-alkylene diisocyanates, cycloaliphatic diisocyanates having 6 to 20 carbon atoms in all or aromatic diisocyanates having 8 to 20 carbon atoms in all, or mixtures thereof.

The diisocyanates and polyisocyanates which can be used preferably have an isocyanate group (calculated as NCO, molecular weight=42) content of from 10 to 60% by weight based on the diisocyanate and polyisocyanate (mixture), more preferably from 15 to 60% by weight, and very preferably from 20 to 55% by weight.

Preference is given to aliphatic and/or cycloaliphatic diisocyanates and polyisocyanates, examples being the abovementioned aliphatic and cycloaliphatic diisocyanates, respectively, or mixtures thereof.

Preference extends to
1) Polyisocyanates containing isocyanurate groups and formed from aromatic, aliphatic and/or cycloaliphatic diisocyanates. Particular preference is given here to the corresponding aliphatic and/or cycloaliphatic isocyanato-isocyanurates and, in particular, to those based on hexamethylene diisocyanate and isophorone diisocyanate. The isocyanurates present are, in particular, trisisocyanatoalkyl or trisisocyanatocycloalkyl isocyanurates, which represent cyclic trimers of the diisocyanates, or are mixtures with their higher homologs comprising more than one isocyanurate ring. The isocyariato-isocyanurates generally have an NCO content of from 10 to 30% by weight, in particular from 15 to 25% by weight, and an average NCO functionality of from 3 to 4.5.
2) Uretdione diisocyanates having aromatically, aliphatically and/or cycloaliphatically attached isocyanate groups, preferably aliphatically and/or cycloaliphatically attached isocyanate groups, and especially those derived from hexamethylene diisocyanate or isophorone diisocyanate. Uretdione diisocyanates are cyclic dimerization products of diisocyanates.

In the formulations of the invention the uretdione diisocyanates can be used as sole component or in a mixture with other polyisocyanates, especially those specified under 1).
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of from 18 to 22% by weight and an average NCO functionality of from 3 to 4.5.
4) Polyisocyanates containing urethane and/or allophanate groups and having aromatically, aliphatically or cycloaliphatically attached, preferably aliphatically or cycloaliphatically attached, isocyanate groups, as obtainable for example by reacting excess amounts of hexamethylene diisocyanate or of isophorone diisocyanate with polyhydric alcohols such as trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups generally have an NCO content of from 12 to 20% by weight and an average NCO functionality of from 2.5 to 3.
5) Polyisocyanates comprising oxadiazinetrione groups, preferably derived from hexamethylene diisocyanate or isophorone diisocyanate. Polyisocyanates of this kind comprising oxadiazinetrione groups can be prepared from diisocyanate and carbon dioxide.
6) Uretonimine-modified polyisocyanates.

The polyisocyanates 1) to 6) can be used in a mixture, including if appropriate in a mixture with diisocyanates.

Compounds used as reaction partners of the polyisocyanates a) are compounds b) having isocyanate-reactive groups, which in accordance with the invention are subdivided into compounds b1) to b4), with b2), b3), and b4) being optional.

Examples of suitable isocyanate-reactive groups are hydroxyl groups, thiol groups, and primary and secondary amino groups. It is preferred to use hydroxyl-containing compounds or monomers, b1) and if appropriate b2). In addition it is also possible to use compounds b3), which have at least two isocyanate-reactive groups, selected from thiol groups and primary and secondary amino groups.

Suitable compounds b1) are those polyols containing structural unit —[—CH₂—CH₂—O—]_{w}— one or more times, the fraction of the structural units —[—CH₂—CH₂—O—]—, calculated at 42 g/mol, in the polyol b1) accounting for a weight fraction of from 10 to 90% by weight, preferably from 10 to 50% by weight, and more preferably 12-35% by weight.

The index w is a positive integer from 1 to 200, preferably from 2 to 200, more preferably from 5 to 100, very preferably from 10 to 100, and in particular from 20 to 50.

The compounds b1) preferably have a molar weight of at least 500 g/mol, more preferably from 800 to 5000 g/mol.

The polyols b1) are preferably polyols with mixed alkoxylation, in which a suitable starter molecule is alkoxylated with ethylene oxide and with at least one further alkylene oxide.

Examples of starter molecules include water, neopentyl glycol, neopentyl glycol hydroxypivalate, 2-ethyl-1,3-propanediol, 2-methyl-1,3-propanediol, 3-ethyl-1,5-pentanediol, 3-methyl-1,5-pentanediol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol, 1,2-propanediol, ethylene glycol, 2,2-dimethyl-1,2-ethanediol, 1,3-propanediol, 1,2-butanediol, 1,3-butanediol, 1,4-butanediol, 1,6-hexanediol, 1,8-octanediol, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt.

Examples of alkylene oxides are propylene oxide, isobutylene oxide, vinyloxirane and/or styrene oxide, preference being given to propylene oxide and/or isobutylene oxide and particular preference to propylene oxide.

Also suitable are glycidyl ethers of aliphatic or aromatic polyols. Products of this kind are available commercially in large numbers. Particular preference is given to polyglycidyl compounds of the bisphenol A, F or B type, their fully hydrogenated derivatives, and glycidyl ethers of polyhydric alcohols, e.g., of 1,4-butanediol, 1,4-cyclohexanedimethanol, neopentyl glycol, of 1,6-hexanediol, of glycerol, trimethylol-propane, and of pentaerythritol. Examples of polyepoxide compounds of this kind are Epikote® 812 (epoxide value: about 0.67 mol/100 g) and Epikote® 828 (epoxide value: about 0.53 mol/100 g), Epikote® 1001, Epikote® 1007 and Epikote® 162 (epoxide value: about 0.61 mol/100 g) from Resolution Performance Products, Rütapox® 0162 (epoxide value: about 0.58 mol/100 g), Rütapox® 0164 (epoxide value: about 0.53 mol/100 g), and Rütapox® 0165 (epoxide value: about 0.48 mol/100 g) from Bakelite AG, and Araldit® DY 0397 (epoxide value: about 0.83 mol/100 g) from Vantico AG.

Preference is given to bisphenol A diglycidyl ether, 1,4-butanediol diglycidyl ether, trimethylolpropane triglycidyl ether, and pentaerythritol tetraglycidyl ether.

The alkylene oxides can be used in a mixture in the alkoxylation, so forming a random copolymer, or, preferably, the straight alkylene oxides can be used in succession, so forming a block copolymer. Particular preference is given to a block copolymer in which ethylene oxide is used as the final alkoxylation step, so that the polyol b1) has at least one primary alcohol group as a terminal structural unit —CH₂—O—H, and with very particular preference has two such terminal structural units.

The polyols b1) can also comprise polyesterpolyols obtained by reacting at least one dihydric or polyhydric alcohol with at least one dibasic or polybasic carboxylic acid. Instead of the free polycarboxylic acids it is also possible to use the corresponding polycarboxylic anhydrides or corresponding polycarboxylic esters of lower alcohols or mixtures thereof to prepare the polyesterpolyols.

The polycarboxylic acids can be aliphatic, cycloaliphatic, araliphatic, aromatic or heterocyclic and can be substituted, if appropriate, by halogen atoms, for example, and/or can be unsaturated.

Examples thereof that may be mentioned include the following: suberic acid, azelaic acid, phthalic acid, isophthalic acid, sodium sulfoisophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, and dimeric fatty acids. Preference is given to dicarboxylic acids of the general formula HOOC—(CH₂)_{y}—COOH, where y is a number from 1 to 20, preferably an even number from 2 to 20, e.g., succinic acid, adipic acid, dodecanedicarboxylic acid, and sebacic acid.

Examples of suitable polyols for preparing the polyesterol include ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexane such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples include ethylene glycol, butane-1,4-diol, hexane-1,6-diol, octane-1,8-diol, and dodecane-1,12-diol. Preference extends to neopentyl glycol and pentane-1,5-diol.

In order in accordance with the invention to incorporate at least one structural unit —[—CH₂—CH₂—O—]— into the polyesterol it is necessary for at least one synthesis component of the polyesterol to be ethylene glycol, a polyethylene glycol having a molar mass of between 106 and 2000, preferably between 106 and 1000, and more preferably between 106 and 500, or an above-described copolymer of ethylene oxide with another alkylene oxide.

Also suitable are lactone-based polyesterdiols, which are homopolymers or copolymers of lactones, preferably hydroxyl-terminated adducts of lactones with suitable difunctional starter molecules. Suitable lactones include preferably those derived from compounds of the general formula HO—(CH₂)_{z}—COOH, where z is a number from 1 to 20 and where one hydrogen atom of a methylene unit may also have been substituted by a C₁ to C₄ alkyl radical. Examples are epsilon-caprolactone, β-propiolactone, γ-butyrolactone and/or methyl-epsilon-caprolactone, and also mixtures thereof.

Examples of suitable starter components are the low molecular mass dihydric alcohols specified above as a synthesis component for the polyesterpolyols. The corresponding polymers of ε-caprolactone are particularly preferred. Lower polyesterdiols or polyetherdiols as well can be used as starters for preparing the lactone polymers. Instead of the polymers of lactones it is also possible to use the corresponding, chemically equivalent polycondensates of the hydroxycarboxylic acids corresponding to the lactones.

Suitable polyols b2) include all known alcohols with a functionality of two or more, provided they do not fall into the above list of the polyols b1). The polyols b2) can, accordingly, also have a molar weight lower than 500 g/mol and a fraction of the structural units —[—CH₂—CH₂—O—]—, calculated at 42 g/mol, of less than 10% or more than 90% by weight.

Examples are polyTHF having a molar mass of between 162 and 1458, poly-1,3-propanediol having a molar mass of between 134 and 1178, poly-1,2-propanediol having a molar mass of between 134 and 1178, trimethylolbutane, trimethylolpropane, trimethylolethane, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, and polyesterols and polyetherols based thereon.

Likewise possible are polyesters formed from starting materials as mentioned above. It is also possible to use polyols based on OH-functionalized polybutadienes, polyacrylates, polysiloxanes, and polycarbonates as monomers b2).

The fraction of the structural units —[—CH₂—CH₂—O—]—, calculated at 42 g/mol, in the sum of the components a)+b1)+b2)+b3)+b4)+c) is in accordance with the invention at least 3% by weight, preferably at least 5% by weight, and more preferably at least 7.5% by weight. In general the fraction is not more than 90% by weight, preferably not more than 75% by weight, and more preferably not more than 50% by weight.

Examples of suitable monomers b3) are hydrazine, hydrazine hydrate, ethylenediamine, propylenediamine, diethylenetriamine, dipropylenetriamine, isophoronediamine, 1,4-cyclohexyldiamine, piperazine or thiols such as 1,2-ethanethiol.

In minor amounts it is also possible to use monofunctional monomers b4) having an isocyanate-reactive group. Their fraction should not exceed 10 mol % relative to NCO groups in component a).

Examples of b4) are methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol), and 2-ethylhexanol.

Furthermore it is also possible for at least one ionic or potentially ionic synthesis component c) to be present. Preferably, however, the polyurethanes of the dispersions of the invention are synthesized without components c).

Suitable components c) are compounds of at least one isocyanate-reactive group and at least one actively dispersing group.

Such compounds are represented, for example, by the general formula
RG-R¹-DG
where
RG is at least one isocyanate-reactive group,
DG is at least one actively dispersing group, and
R¹ is an aliphatic, cycloaliphatic or aromatic radical comprising 1 to 20 carbon atoms.

Examples of RG are —OH, —SH, —NH₂ or —NHR², where R² can be methyl, ethyl, isopropyl, n-propyl, n-butyl, isobutyl, sec-butyl, tert-butyl, cyclopentyl or cyclohexyl.

With preference component c) is, for example, mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalinecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, and the alkali metal, alkaline earth metal or ammonium salts of these acids, and, with particular preference, the aforementioned monohydroxycarboxylic and monohydroxysulfonic acids and also monoaminocarboxylic and monoaminosulfonic acids.

To prepare the dispersion the aforementioned acids, if not already in salt form, are fully or partly neutralized, preferably with alkali metal salts or amines, tertiary amines for preference.

The dispersion of the invention is prepared by means of emulsion polymerization.

Generally in these processes, in a first step, a mixture is prepared from the monomers a) and b) and also, if appropriate, c), the required amount of emulsifiers and/or protective colloid, hydrophobic additive, if appropriate, and water, and an emulsion is produced from said mixture.

Preferably, in a first step, the organic phase is prepared homogeneously and in a second step this organic phase is added to a water phase or else a water phase is added to the organic phase thus prepared.

With equal preference it is possible to introduce a portion of the synthesis components to start with and to meter in the remaining portion. Preferably the synthesis components a) and those having a molar weight of more than 500 g/mol are introduced initially and the remaining synthesis components are added; with particular preference the synthesis components b1) can be introduced initially and the remaining synthesis components added.

In accordance with the invention the average particle size (z-average) in the dispersion thus prepared, as measured by dynamic light scattering with the Malvern® Autosizer 2 C, is generally <1000 nm, preferably <500 nm, and with particular preference <100 nm. Normally the diameter is from 20 to 80 nm.

In order to produce the emulsion it is necessary, in accordance with the invention, to deploy an energy of not more than 10⁸ W/m³.

It is advantageous to carry out the preparation of the emulsion with sufficient rapidity that the emulsifying time is small in comparison to the reaction time of the monomers with one another and with water.

In one preferred embodiment of the process of the invention the entirety of the emulsion is prepared with cooling at temperatures below room temperature. Preparation of the emulsion is preferably accomplished within a time of less than 10 minutes. Raising the temperature of the emulsion with stirring completes the conversion. The reaction temperatures are situated between room temperature and 120° C., preferably between 60° C. and 100° C. If necessary it is possible to apply pressure in order to keep low-boiling components liquid.

When producing emulsions it is general practice to use ionic and/or nonionic emulsifiers and/or protective colloids or stabilizers as surface-active compounds.

A detailed description of suitable protective colloids can be found in Houben-Weyl, Methoden der organischen Chemie, volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are usually below 2000 g/mol. Where mixtures of surface-active substances are used it will be appreciated that the individual components must be compatible with one another, something which in case of doubt can be checked by means of a few simple preliminary tests. It is preferred to use anionic and nonionic emulsifiers as surface-active substances. Customary accompanying emulsifiers are, for example, ethoxylated fatty alcohols (EO units: 3 to 50, alkyl: C₈ to C₃₆), ethoxylated mono-, di-, and tri-alkylphenols (EO units: 3 to 50, alkyl: C₄ to C₉), alkali metal salts of dialkyl esters of sulfosuccinic acid, and alkali metal salts and/or ammonium salts of alkyl sulfates (alkyl: C₈ to C₁₂), of ethoxylated alkanols (EO units: 4 to 30, C₉), of alkylsulfonic acids (alkyl: C₁₂ to C₁₈), and of alkylarsulfonic acids (alkyl: C₉ to C₁₈).

Suitable emulsifiers can also be found in Houben-Weyl, Methoden der organischen Chemie, volume 14/1, Makromolekulare Stoffe, Georg Thieme Verlag, Stuttgart, 1961, pages 192 to 208.

Examples of emulsifier tradenames include Dowfax® 2 A1 from Dow, Emulan® NP 50, Emulan® OG, Emulsifier 825, and Emulsifier 825 S, Nekanil® 904 S from BASF, Texapon® NSO from Henkel Corporation, Lumiten® 1-RA and Lumiten E 3065 from BASF, Dextrol® OC 50 from AVEBE GmbH, Steinapol NLS from Goldschmidt REWO GmbH, etc.

Based on the amount of monomers present in the aqueous emulsion this quantity of emulsifiers is generally in the range from 0.1 to 10% by weight. As already mentioned it is possible to add protective colloids to the emulsifiers at the side, these protective colloids having the capacity to stabilize the disperse distribution of the aqueous polymer dispersion which ultimately results. Irrespective of the amount of emulsifier used it is possible to employ the protective colloids in amounts of up to 50% by weight—for example, in amounts of from 1 to 30% by weight based on the monomers.

As costabilizers as hydrophobic additive it is possible to admix the monomers with substances having a water solubility of less than 5×10⁻⁵, preferably 5×10⁻⁷ g/l in amounts of from 0.01% by weight to 10% by weight, preferably 0.1-1% by weight. Examples are hydrocarbons such as hexadecane, halogenated hydrocarbons, silanes, siloxanes, hydrophobic oils (olive oil), dyes, etc. In their stead it is also possible for blocked polyisocyanates to take on the function of the hydrophobe.

The reaction is preferably conducted in the presence of a catalyst.

In one preferred version first of all a mixture is prepared from the monomers, emulsifiers and/or protective colloids, and also, if appropriate, hydrophobic additive and water. Then an emulsion is produced and is heated with stirring. After the required reaction temperature has been reached the catalyst is added via the water phase. Particular preference is given to adding a hydrophobic catalyst via the water phase. The water solubility of the hydrophobic catalyst is preferably ≦1 g/l.

Naturally, however, the catalyst can also be added to the oil phase of the emulsion, i.e., to the monomer phase, before dispersion is carried but, or can be added to the water phase immediately after the emulsion has been prepared. Subsequently heating is carried out with stirring.

Suitable catalysts include in principle all those catalysts which are commonly used in polyurethane chemistry.

These are, for example, organic amines, especially tertiary aliphatic, cycloaliphatic or aromatic amines, and/or Lewis-acidic organometallic compounds. Examples of suitable Lewis-acidic organometallic compounds include tin compounds, such as tin(II) salts of organic carboxylic acids, e.g., tin(II) acetate, tin(II) octoate, tin(II) ethylhexoate, and tin(II) laurate, and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. Metal complexes are also possible, such as acetylacetonates of iron, of titanium, of aluminum, of zirconium, of manganese, of nickel, and of cobalt. Further metal catalysts are described by Blank et al. in Progress in Organic Coatings, 1999, Vol. 35, pages 19-29.

Preferred Lewis-acidic organometallic compounds are dimethyltin diacetate, dibutyltin dibutyrate, dibutyltin bis(2-ethylhexanoate), dibutyltin dilaurate, diocyttin dilaurate, zirconium acetylacetonate and zirconium 2,2,6,6-tetramethyl-3,5-heptanedionate.

Bismuth and cobalt catalysts as well, and also cesium salts, can be used as hydrophobic catalysts. Suitable cesium salts include those compounds in which the following anions are employed: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, where n stands for numbers from 1 to 20.

Preference here is given to cesium carboxylates in which the anion conforms to the formulae (CₙH₂ₙ₋₁O₂)⁻ and (Cₙ₊₁H₂ₙ₋₂O₄)²⁻, with n being from 1 to 20. Particularly preferred cesium salts have monocarboxylate anions of the general formula (CₙH₂ₙ₋₁O₂)⁻where n stands for the numbers from 1 to 20. Particular mention may be made in this context of the formate, acetate, propionate, hexanoate, and 2-ethylhexanoate.

Examples that may be mentioned of customary organic amines include the following: triethylamine, 1,4-diazabicyclo[2.2.2]octane, tributylamine, dimethylbenzylamine, N,N,N′,N′-tetramethylethylenediamine, N,N,N′,N′-tetramethylbutanediamine, N,N,N′,N′-tetramethylhexane-1,6-diamine, dimethylcyclohexylamine, dimethyidodecylamine, pentamethyldipropylenetriamine, pentamethyldiethylenetriamine, 3-methyl-6-dimethylamino-3-azapentol, dimethylaminopropylamine, 1,3-bisdimethylaminobutane, bis(2-dimethylaminoethyl) ether, N-ethylmorpholine, N-methylmorpholine, N-cyclohexylmorpholine, 2-dimethylaminoethoxyethanol, dimethylethanolamine, tetramethylhexamethylenediamine, dimethylamino-N-methylethanolamine, N-methylimidazole, N-formyl-N,N′-dimethylbutylenediamine, N-dimethylaminoethylmorpholine, 3,3′-bisdimethylamino-di-n-propylamine and/or 2,2′-dipiparazine diisopropyl ether, dimethylpiparazine, tris(N,N-dimethylaminopropyl)-s-hexahydrotriazine, imidazoles such as 1,2-dimethylimidazole, 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole.

Preferred organic amines are trialkylamines having independently of one another two C₁ to C₄ alkyl radicals and one alkyl or cycloalkyl radical having 4 to 20 carbon atoms, examples being dimethyl-C₄-C₁₅-alkylamine such as dimethyidodecylamine or dimethyl-C₃-C₈-cycloalkylamine. Likewise preferred organic amines are bicyclic amines which may if appropriate comprise a further heteroatom such as oxygen or nitrogen, an example being 1,4-diazabicyclo[2.2.2]octane.

Naturally it is also possible to use mixtures of two or more said compounds as catalysts.

The catalysts are used preferably in an amount of from 0.0001 to 10% by weight, more preferably in an amount of from 0.001 to 5% by weight, based on the total amount of the monomers used.

The polyurethane dispersions can comprise commercially customary auxiliaries and additives such as blowing agents, defoamers, emulsifiers, thickeners, crosslinkers, fillers, thixotropic agents, colorants such as dyes and pigments, antioxidants, oxidation inhibitors, stabilizers, activators (accelerators), devolatilizers, luster agents, antistats, flame retardants, leveling assistants, binders, antifoams, fragrances, surfactants, viscosity modifiers, plasticizers, tackifier resins, chelating agents or compatibilizers.

The dispersion of the invention is used for producing aqueous coating materials, adhesives, and sealants, for example, for coating wood, wood veneer, paper, board, card, textile, leather, nonwoven, plastics surfaces, glass, ceramic, mineral building materials or metals, including coated metals. It can also be used to produce films or sheets and also for impregnating, say, textiles or leather, as dispersants and pigment grinding compositions, as primers and adhesion promoters, as hydrophobicizers, and also as a laundry detergent additive and as an additive to cosmetic formulations. It is also possible for the dispersions of the invention to be used for producing moldings or hydrogels, e.g., for optical lenses.

The dispersions of the invention can be used, further, as seed in the implementation of a seed polymerization. For this the dispersions of the invention can, for example, be emulsified and reacted in a reactor and then the polymerization for which the dispersions of the invention serve as seed (in situ seed) can be conducted. The dispersions of the invention can of course also be prepared separately and introduced into a reactor, and the seed polymerization then initiated. Implementing such seed polymerizations is known to a person skilled in the art and is described for example in Baumstark and Schwartz, Dispersionen für Bautenfarben, Vincentz Verlag 2001 p.42 and Encyclopedia of polymer science and technology, plastics, resins, rubbers fibers, Vol 5, J. Wiley and Sons, New York 1966, page 847.

The seed polymerization is preferably conducted as described in U.S. Pat. No. 5,189,107 col. 2 l.29 to col 9 l.55 or in WO 97/12921 from p.3 l.19 and preferably as described therein at p.22 l.9 to p.23 l.8. The disclosure content of both these documents is hereby incorporated by way of reference into the present description.

The invention is described in more detail below with reference to examples.

Ppm and percentage figures used in this text, unless indicated otherwise, are by weight.

### EXAMPLES

### Example 1

9.5 g of a block copolymer of propylene oxide (PO) and ethylene oxide (EO) (terminal) with 21.3% by weight EO and an OH number to DIN 53240 (OHN) of 26.7 mg KOH/g are mixed with 1.07 g of 3-methylpentane-1,5-diol and 2.5 g of isophorone diisocyanate (IPDI). The oil phase is stirred into 28.8 g of fully demineralized (DI) water containing 3.4 g of Steinapol NLS in 15% form from Goldschmidt REWO GmbH using a magnetic stirrer at 750 rpm. After 10 minutes the mixture is homogeneous. The emulsion is heated to 50° C. and 2 drops of dibutyltin dilaurate (DBTL) are added. After 5 hours it is filtered through a 40 μm filter and the solids content is found to be 28.8%. The particle size is 35.5 nm.

### Example 2

8.7 g of a block copolymer of PO and EO (terminal) with 13% by weight EO and an OHN of 35.2 mg KOH/g are mixed with 1.29 g of 3-methylpentane-1,5-diol and 3 g of IPDI. The oil phase is stirred into 28.7 g of DI water containing 3.4 g of Steinapol NLS in 15% form. After 10 minutes the mixture is homogeneous. The emulsion is heated at 50° C. and 2 drops of DBTL are added. After 5 h it is filtered through a 40 μm filter and the solids content is found to be 28.1%. The particle size is 45.8 nm.

### Example 3

12 g of a block copolymer of PO and EO (terminal) with 21.3% by weight EO and an OHN of 26.7 mg KOH/g are mixed with 0.13 g of butane-1,4-diol and 1.07 g of 4,4′-/2,4′-methylenedi(phenyl isocyanate) (MDI). The oil phase is stirred into 29 g of DI water containing 3.5 g of Steinapol NLS in 15% form. After 10 minutes the mixture is homogeneous. The emulsion is heated at 50° C. and 2 drops of DBTL are added. After 5 h it is filtered through a 40 μm filter and the solids content is found to be 28.1%. The particle size is 156 nm.

### Example 4

7 g of a block copolymer of PO and EO (terminal) with 18.6% by weight EO and an OHN of 55.2 mg KOH/g are mixed with 1.6 g of 3-methylpentane-1,5-diol, 0.31 g of hexadecane and 3.8 g of IPDI. The oil phase is stirred into 28.1 g of DI water containing 3.3 g of Steinapol NLS in 15% form. After 10 minutes the mixture is homogeneous. The emulsion is heated at 60° C. and 2 drops of K-Kat XC-6212 from King Industries are added. After 5 h it is filtered through a 40 μm filter and the solids content is found to be 28.2. The particle size is 31.2 nm.

### Example 5

### Preparation of a polyesterdiol

328.7 g of isophthalic acid, 1003.4 g of adipic acid, 351.7 g of neopentyl glycol, 605.5 g of hexane-1,6-diol and 1024.5 g of polyethylene glycol 400 are weighed out into a vessel, melted and reacted at a maximum temperature of 232° C. until the acid number is 5.5 mg/g. The material is drained off at 80° C.

Acid number: 5.11 mg KOH/g to DIN 53402

OH number: 87.7 mg KOH/g to DIN 53240

### Example 6

25.7 g of the polyesterdiol from Example 5 are mixed with 3.6 g of butane-1,4-diol and 13.4 g of IPDI. The oil phase is stirred into 97 g of DI water containing 5.7 g of Steinapol NLS in 15% form. After 10 minutes the mixture is homogeneous. The emulsion is heated to 60° C. and 6 drops of DBTL are added. After 5 h it is filtered through a 40μ filter and the solids content is found to be 27%. The particle size is 65.6 nm.

### Example 7

9.6 g of a block copolymer of PO and EO (terminal) with 21.3% by weight EO and an OHN of 26.7 mg KOH/g are mixed with 0.95 g of neopentyl glycol and 2.54 g of IPDI. The oil phase is stirred into 28.8 g of DI water containing 3.5 g of Steinapol NLS in 15% form. After 10 minutes the mixture is homogeneous. The emulsion is heated at 50° C. and 2 drops of DBTL are added. After 5 h it is filtered through a 40 μm filter and the solids content is found to be 26.9%. The particle size is 76.7 nm.

### Example 8

8.7 g of a block copolymer of PO and EO (terminal) with 13% by weight EO and an OHN of 35.2 mg KOH/g are mixed with 1.14 g of neopentyl glycol and 3 g of IPDI. The oil phase is stirred into 28.3 g of DI water containing 3.4 g of Steinapol NLS in 15% form. After 10 minutes the mixture is homogeneous. The emulsion is heated at 50° C. and 2 drops of DBTL are added. After 5 h it is filtered through a 40 μm filter and the solids content is found to be 27.3%. The particle size is 50.2 nm.

1. An aqueous primary dispersion comprising at least one polyurethane obtainable by reacting
a) at least one polyisocyanate,
b1) at least one polyol containing the structural unit —[—CH₂—CH₂]— one or more times, the structural unit —[—CH₂—CH₂—O]— deriving from a synthesis component selected from the group comprising ethylene glycol, polyethylene glycol having a molar mass of between 106 and 2000, and ethylene oxide,
b2) if appropriate at least one polyol other than b1),
b3) if appropriate at least one compound containing at least two isocyanate-reactive groups selected from thiol groups and primary and secondary amino groups,
b4) if appropriate at least one monofunctional monomer having an isocyanate-reactive group, and
c) if appropriate at least one ionic or potentially ionic synthesis component,
wherein
the fraction of the structural units —[—CH₂—CH₂]—, calculated at 44 g/mol, in the polyol b1) is from 10 to 90% by weight and the fraction of the structural units —[—CH₂—CH₂—O—]—, calculated at 44 g/mol, in the sum of the components a)+b1)+b2)+b3)+b4)+c) is at least 3% by weight.

2. The primary dispersion according to claim 1, wherein the molecular weight of the polyol b1) is at least 500 g/mol.

3. The primary dispersion according to claim 1, wherein the polyol b1) is a copolymer comprising ethylene oxide and propylene oxide.

4. The primary dispersion according to claim 3, wherein the copolymer is a block copolymer.

5. The primary dispersion according to claim 1, wherein the polyol b1) includes at least one terminal structural unit —CH₂—O—H.

6. The primary dispersion according to claim 1, wherein the polyol b1) is a polyesterol.

7. The primary dispersion according to claim 1, wherein the average particle size as measured by dynamic light scattering using the Malvern® Autosizer 2 C is below 100 nm.

8. A process for preparing a primary dispersion according to claim 1, which comprises reacting components a), b 1), if appropriate b2), if appropriate b3), and if appropriate b4) in the presence of water.

9. The process for preparing a primary dispersion according to claim 1, wherein dispersing takes place with shear forces below 10⁸ W/cm³.

10. A method of coating a substrate comprising applying the aqueous primary dispersion of claim 1 to the substrate thereby coating the substrate.

11. The method of claim 10, wherein the substrate comprises a material selected from the group consisting of wood, wood veneer, paper, board, card, textile, leather, nonwoven, plastic, glass, ceramic, metals, coated metals, and mineral building materials.

12. The primary dispersion according to claim 2, wherein the polyol b1) is a copolymer comprising ethylene oxide and propylene oxide.

13. The primary dispersion according to claim 2, wherein the polyol b1) includes at least one terminal structural unit —CH₂—O—H.

14. The primary dispersion according to claim 3, wherein the polyol b1) includes at least one terminal structural unit —CH₂—O—H.

15. The primary dispersion according to claim 4, wherein the polyol b1) includes at least one terminal structural unit —CH₂—O—H.

16. The primary dispersion according to claim 2, wherein the polyol b1) is a polyesterol.

17. The primary dispersion according to claim 2, wherein the average particle size as measured by dynamic light scattering using the Malvern® Autosizer 2 C is below 100 nm.

18. The primary dispersion according to claim 3, wherein the average particle size as measured by dynamic light scattering using the Malvern® Autosizer 2 C is below 100 nm.

19. The primary dispersion according to claim 4, wherein the average particle size as measured by dynamic light scattering using the Malvern® Autosizer 2 C is below 100 nm.

20. The primary dispersion according to claim 5, wherein the average particle size as measured by dynamic light scattering using the Malvern® Autosizer 2 C is below 100 nm.
